(19) United States
(12) Patent Application Publication
(10) Pub. No.: US 2023/0249740 A1
(43) Pub. Date: Aug. 10, 2023

(54) MOTOR SUPPORTING STRUCTURE FOR STEERING DEVICE

(71) Applicant: NSK LTD., Tokyo (JP)

(72) Inventors: Shigeo SHINOHARA, Gunma (JP); Daigoh FUJII, Gunma (JP)

(73) Assignee: NSK LTD., Tokyo (JP)

(21) Appl. No.: 18/013,100

(22) PCT Filed: Sep. 15, 2021
(86) PCT No.: PCT/JP2021/033967

§ 371 Date: Dec. 27, 2022

(30) Foreign Application Priority Data
Feb. 24, 2021 (JP) 2021-027786

(51) Int. Cl. B62D 5/04; B62D 3/12

(52) U.S. Cl. CPC B62D 5/0424; B62D 3/12

(57) ABSTRACT

A motor supporting structure for a steering device includes a motor one end of which has an output shaft extending along the axial direction of the rack bar, a motor peripheral part that is disposed on the other end of the motor, and a first fastener that includes a first bolt and that fastens the motor and the motor peripheral part in the axial direction. The rack housing includes a first support that supports one end of the power generator unit and a second support that supports the other end of the power generator unit. The second support has a tip portion connected to the other end of the power generator unit. The tip portion of the second support has a first hole through which the shaft of the first bolt passes, and is fastened by a first fastener, together with the motor and the motor peripheral part.

### FIELD

The present disclosure relates to a motor supporting structure for a steering device.

### BACKGROUND

As a type of steering devices, there has been an electric power steering device. Such an electric power steering device is provided with a motor to assist a driver's steering operation. As a type of such an electric power steering device, there has been a rack-assisted electric power steering device in which the assisting force generated by a motor is input to a rack bar. Such a rack-assisted electric power steering device includes a rack housing for housing the rack bar. The rack housing is fixed to the body of a vehicle. The rack housing then supports the motor. In a conventional motor supporting structure, the rack housing supports only one end of the motor that has an output shaft. Hereafter, such a structure supporting only one of the two ends of the motor will be referred to as a cantilever structure.

The strength by which the cantilever structure supports the motor is weak. Therefore, the part supporting the motor may become deformed or damaged. In addition, vibrations from the moving vehicle may be communicated to the motor, and cause the motor to emit noise. For these reasons, a fix-ended structure supporting both ends of the motor has been disclosed in Patent Literature 1.

### CITATION LIST

### Patent Literature

Patent Literature 1: Japanese Patent Application Laid-open No. 2015-174615

### SUMMARY

### Technical Problem

In the fix-ended structure according to Patent Literature 1, bolts are used to connect a support for supporting the other end of the motor to the motor. Therefore, bolts are required, so that the number of parts is increased. It is also necessary to provide female threaded holes for screwing the bolts. In other words, it is necessary to machine the female threaded holes to the motor. Thus, an increased number of man-hours is required to manufacture the steering device.

The present disclosure is made in consideration of the problems described above, and an object of the present disclosure is to provide a motor supporting structure for a steering device capable of reducing the number of parts and the number of manufacturing man-hours.

### Solution to Problem

To achieve the above object, a motor supporting structure for a steering device according to an embodiment of the present disclosure, the motor supporting structure comprising: a rack bar; a rack housing in which the rack bar is housed; and a power generator unit that generates power for moving the rack bar, wherein the power generator unit includes: a motor one end of which has an output shaft extending along an axial direction of the rack bar; a motor peripheral part that is disposed on another end of the motor; and a first fastener that includes a first bolt, and that fastens the motor and the motor peripheral part in an axial direction, the rack housing includes: a first support that supports one end of the power generator unit; and a second support that supports another end of the power generator unit, the second support has a tip portion that is connected to the other end of the power generator unit, and the tip portion of the second support has a first hole through which a shaft of the first bolt passes, and is fastened by the first fastener, together with the motor and the motor peripheral part.

By fastening with the first fastener, the tip portion of the second support is connected to the other end of the power generator unit. In other words, the fastener for connecting the motor to the motor peripheral part is also used as the fastener for connecting the second support to the power generator unit. Therefore, the need for one fastener is eliminated, so that the number of parts becomes reduced. In addition, because the need for one fastener is eliminated, the work for providing a female threaded hole in the motor or the motor peripheral part is reduced, and the number of man-hours required to manufacture the steering device is also reduced.

As a desirable embodiment of the motor supporting structure for a steering device, the motor has a first flange that protrudes from an outer peripheral surface of the other end of the motor and that is fastened by the first fastener, the motor peripheral part has a cover member that closes an opening on the other end of the motor, and the cover member has a second flange that is fastened by the first fastener and that abuts against the first flange.

The first flange and the second flange are fastened in a manner abutting against each other. In other words, the tip portion of the second support is not interposed between the first flange and the second flange. This configuration suppresses formation of a gap between the motor and the cover member, so that sealing of the cover member is ensured.

As a desirable embodiment of the motor supporting structure for a steering device, a rotor of the motor includes a magnet, and the motor peripheral part has a rotation angle sensor that detects a change in a magnetic field of the magnet.

Because the tip portion of the second support is not interposed between the first flange and the second flange, the distance between the rotation angle sensor and the magnets is kept small. Therefore, the rotation angle sensor can detect a change in the magnetic field of the magnets accurately.

As a desirable embodiment of the motor supporting structure for a steering device, an elastic material is interposed between the tip portion of the second support and the first flange or the second flange adjacent to the tip portion in the axial direction.

The vibrations transmitted from the first flange or the second flange to the second support are absorbed by the elastic material. Therefore, the second support vibrates less, and the second support generates less vibrational noise.

As a desirable embodiment of the motor supporting structure for a steering device, the motor or the motor peripheral part is provided with a female threaded hole into which the first bolt is screwed.

The need for the nut into which the first bolt is screwed is eliminated, so that the number of parts is reduced.

As a desirable embodiment of the motor supporting structure for a steering device, the first hole is larger than a diameter of a shaft of the first bolt.

One end of the power generator unit is connected to the first support. Therefore, the first bolt connected to the power generator unit may become displaced with respect to a predetermined position because of an assembly tolerance between the power generator unit and the first support. Because the first hole is larger than the shaft of the first bolt, the displacement of the first bolt mentioned above can be tolerated. Therefore, the ease of installation of the second support is improved.

As a desirable embodiment of the motor supporting structure for a steering device, the second support is manufactured integrally with the rack housing.

The need for a bolt connecting the second support to the rack housing is eliminated, so that the number of parts is reduced.

As a desirable embodiment of the motor supporting structure for a steering device, an elastic material is interposed between the base portion of the second support and the rack housing.

The elastic material absorbs the vibrations transmitted from the rack housing to the stay. The stay thus vibrates less, and the stay generates less vibrational noise.

As a desirable embodiment of the motor supporting structure for a steering device, the second support has a base portion that is an end on an opposite side of the tip portion and provided with a second hole, and the base portion is fastened to the rack housing by a second bolt.

Because the second support is a body separate from the rack housing, it is possible to replace only the second support. Therefore, it is highly convenient because only the second support can be replaced when the second support is damaged or the like.

As a desirable embodiment of the motor supporting structure for a steering device, the rack housing has: a rib that protrudes from an outer peripheral surface of the rack housing to increase strength of the rack housing; and a boss that protrudes from the outer peripheral surface of the rack housing, and into which the second bolt is screwed, and an amount by which the boss protrudes is equal to or less than an amount by which the rib protrudes.

The amount by which the boss protrudes is equal to or less than the amount by which the rib, which is the existing configuration, protrudes. Therefore, even if the boss is provided to the rack housing, little impact is given to the design of the mold (so-called casting plan) for the rack housing, and the rack housing can be manufactured in the manner conventionally done.

As a desirable embodiment of the motor supporting structure for a steering device, the second hole is larger than a diameter of the shaft of the second bolt.

The second support can be radially moved about the shaft of the second bolt, and be fixed to the rack housing. Therefore, displacement due to the assembly tolerance can be tolerated, and the ease of installation of the second support is improved.

As a desirable embodiment of the motor supporting structure for a steering device, the second support is formed by changing shape of a long plate-like metal piece, the first hole and the second hole are formed through the metal piece in a thickness direction, the second support has a middle part extending between the tip portion and the base portion, and the middle part is twisted, and the first hole and the second hole face different directions.

The second support is plate-shaped. Therefore, it is possible to reduce the weight. The second support has a twisted middle part, so as to allow the first hole and the second hole to face different directions. Therefore, it is possible to accommodate not only the direction in which the shaft of the first bolt passes therethrough, but also the direction in which the shaft of the second bolt passes therethrough.

As a desirable embodiment of the motor supporting structure for a steering device, the second support is formed by changing shape of a long plate-like metal piece, the first hole and the second hole are formed through the metal piece in a thickness direction, the second support has a middle part extending between the tip portion and the base portion, and the middle part is bent, and the first hole and the second hole face different directions.

The second support is plate-shaped. Therefore, it is possible to reduce the weight. The second support has a bent middle part, so as to allow the first hole and the second hole to face different directions. Therefore, it is possible to accommodate not only the direction in which the shaft of the first bolt passes therethrough, but also the direction in which the shaft of the second bolt passes therethrough.

As a desirable embodiment of the motor supporting structure for a steering device, the second support has an L shape.

The length of the second support is reduced relatively and the support rigidity of the second support is improved.

### Advantageous Effects of Invention

With the motor supporting structure of the steering device according to the present disclosure, the number of parts can be reduced. It is also possible to reduce the number of man-hours required to manufacture the steering device.

### BRIEF DESCRIPTION OF DRAWINGS

FIG. 1 is a schematic diagram of an electric power steering device according to a first embodiment.

FIG. 2 is an enlarged perspective view of an extract of a housing and elements near the housing included in the electric power steering device according to the first embodiment.

FIG. 3 is an enlarged perspective view of a central part of a rack housing according to the first embodiment.

FIG. 4 is an enlarged view of elements near a stay illustrated in FIG. 1.

FIG. 5 is a schematic of an extract only of the stay according to the first embodiment.

FIG. 6 is a VI-VI arrow cross-sectional view of FIG. 4.

FIG. 7 is a VII-VII arrow cross-sectional view of FIG. 4.

FIG. 8 is an enlarged view of the elements near a stay in an electric power steering device according to a second embodiment.

FIG. 9 is an enlarged view of the elements near a stay in an electric power steering device according to a third embodiment.

FIG. 10 is an enlarged view of the elements near a stay in an electric power steering device according to a fourth embodiment.

FIG. 11 is an enlarged view of the elements near a stay in an electric power steering device according to a fifth embodiment.

FIG. 12 is a cross-sectional view cut along the shaft of a first bolt of an electric power steering device according to a sixth embodiment.

FIG. 13 is a cross-sectional view cut along the shaft of a first bolt of an electric power steering device according to a seventh embodiment.

FIG. 14 is a cross-sectional view cut along the shaft of a first bolt of an electric power steering device according to an eighth embodiment.

FIG. 15 is a cross-sectional view cut along the shaft of a first bolt of an electric power steering device according to a ninth embodiment.

### DESCRIPTION OF EMBODIMENTS

The present disclosure will now be explained in detail with reference to the drawings. Embodiments of the present disclosure explained below (hereinafter referred to as “embodiments”) are not intended to limit the scope of the present disclosure in any way. In addition, elements included in the embodiments described below include those that can be easily come up with by those skilled in the art, those that are substantially the same, and those that are within the scope of what is called equivalent. Furthermore, the elements disclosed in the embodiments below may be combined as appropriate.

### First Embodiment

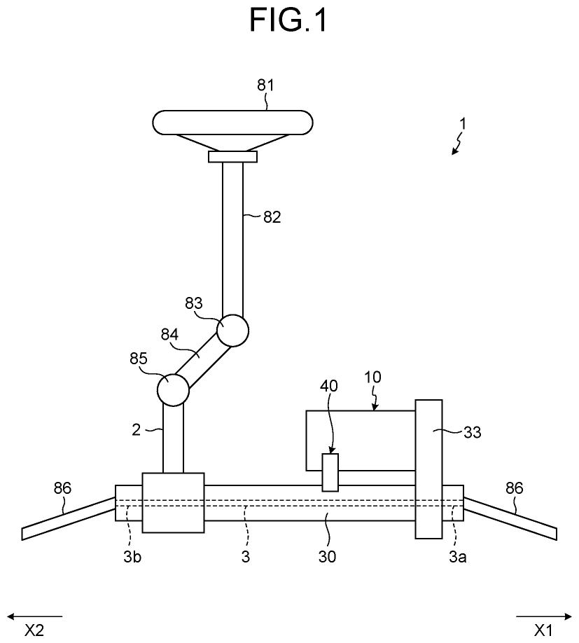

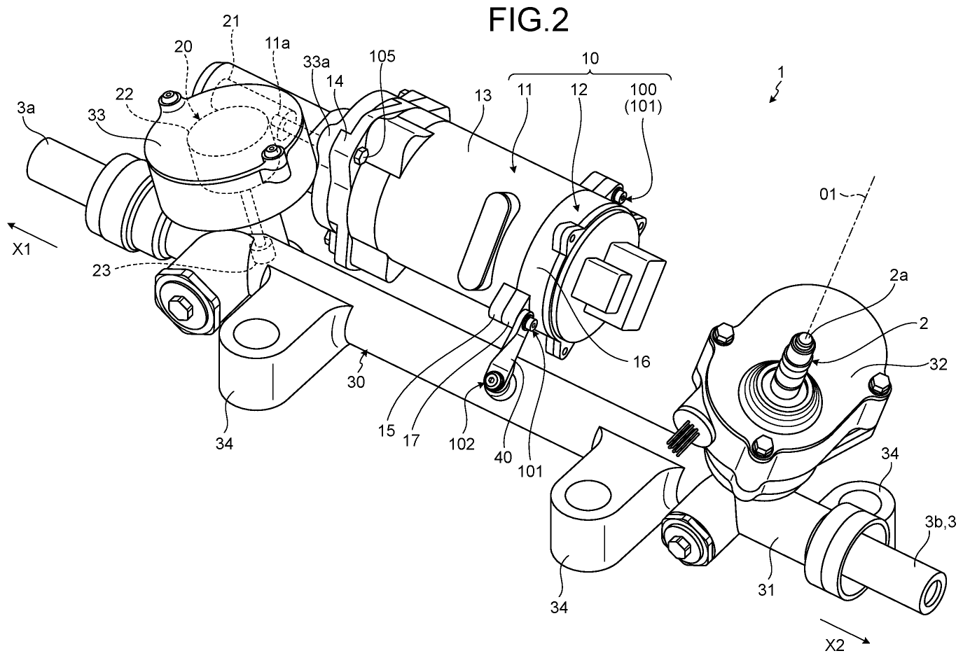

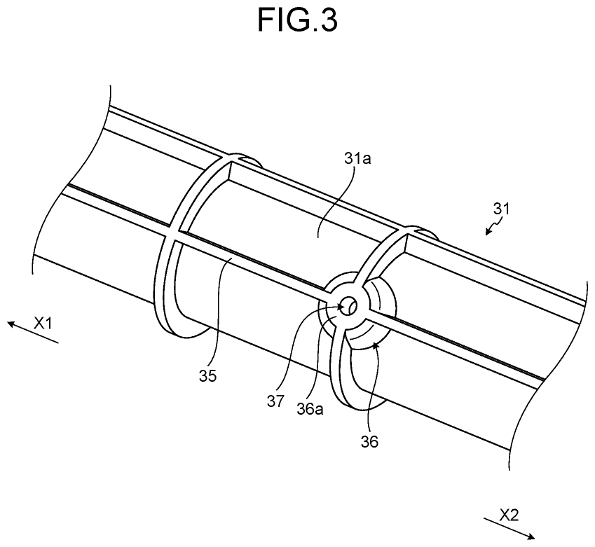

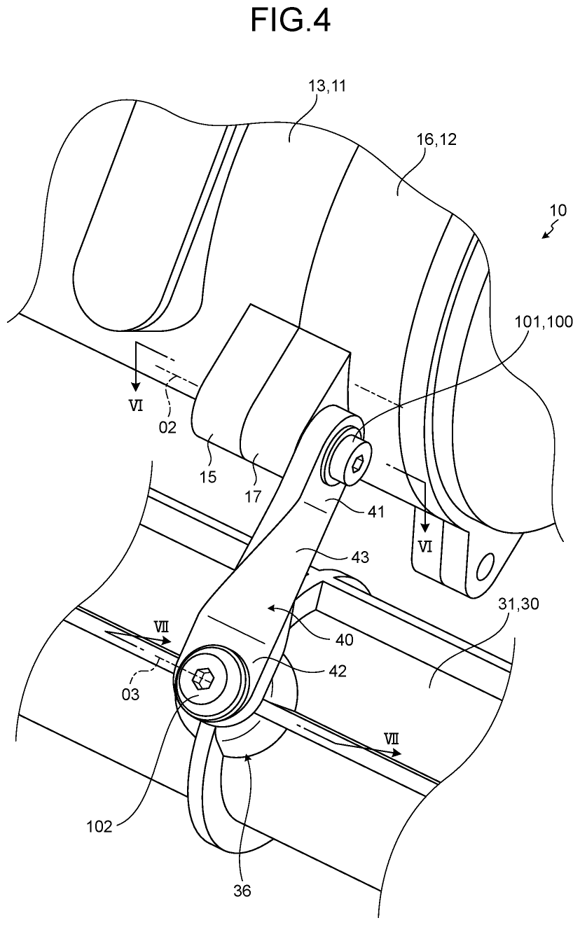

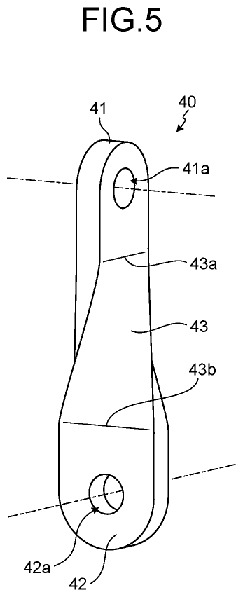

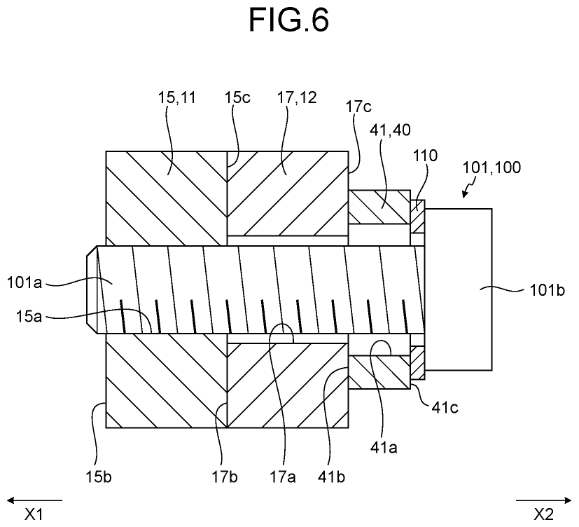

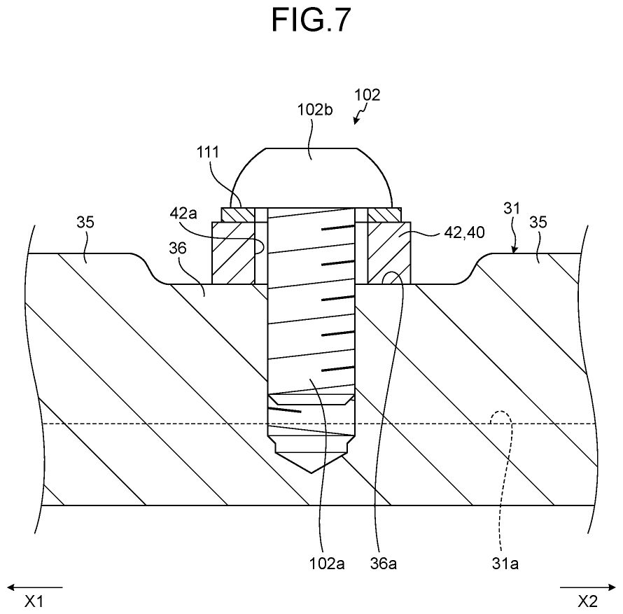

FIG. 1 is a schematic diagram of an electric power steering device according to a first embodiment. FIG. 2 is an enlarged perspective view of an extract of a housing and elements near the housing included in the electric power steering device according to the first embodiment. FIG. 3 is an enlarged perspective view of a central part of a rack housing according to the first embodiment. FIG. 4 is an enlarged view of elements near a stay illustrated in FIG. 2. FIG. 5 is a schematic of an extract only of the stay according to the first embodiment. FIG. 6 is a VI-VI arrow cross-sectional view of FIG. 4. FIG. 7 is a VII-VII arrow cross-sectional view of FIG. 4.

An electric power steering device 1 is a device for steering wheels, and is installed in a front part of the body of a vehicle. As illustrated in FIG. 1, the electric power steering device 1 includes a steering wheel 81, a steering column shaft 82, a universal joint 83, an intermediate shaft 84, a universal joint 85, a steering pinion 2, a rack bar 3, a power generator unit 10, a reduction gear 20 (not illustrated in FIG. 1; see FIG. 2), a housing 30, and a stay 40.

The steering wheel 81 is connected to the steering column shaft 82. The steering column shaft 82, the intermediate shaft 84, and the steering pinion 2 are connected via the universal joint 83 and the universal joint 85. The steering pinion 2 meshes with a first rack (not illustrated) of the rack bar 3. The rack bar 3 is supported by the housing 30 in a manner movable in the width directions of the vehicle (in the direction indicated by arrows X1 and X2). Both ends 3a and 3b of the rack bar 3 are connected to wheels not illustrated via tie rods 86.

When a driver operates the steering wheel 81, the operation torque is transmitted to the steering pinion 2, and the steering pinion 2 rotates about an axis O1 (see FIG. 2). As a result, the rack bar 3 moves toward the right or left of the vehicle (see arrows X1 and X2 in FIG. 1), and steers the wheels. Hereafter, the direction parallel to the rack bar 3 will be referred to as an axial direction. Among the first directions X, the direction to which one end 3a of the rack bar 3 points will be referred to as a first direction X1. Among the first directions X, the direction to which the other end 3b of the rack bar 3 points will be referred to as a second direction X2.

The power generator unit 10 is a part that generates the power for moving the rack bar 3. As illustrated in FIG. 2, the power generator unit 10 includes a motor 11, a motor peripheral part 12, and first fasteners 100. The motor 11 includes an outer cylinder 13, a stator (not illustrated) provided inside the outer cylinder 13, a rotor (not illustrated) rotatably supported inside the stator, and an output shaft 11a integrated with the rotor. The motor 11 is disposed in such a manner that the output shaft 11a extends in parallel with the axial direction. In the present disclosure, the motor 11 may also be disposed in such a manner that the output shaft 11a extends along an axial direction that is somewhat inclined with respect to the axial direction of the rack bar 3. The motor 11 is disposed in such a manner that the output shaft 11a points to the first direction X1. The outer cylinder 13 has a cylindrical shape, and has openings (not illustrated) on its ends in the first direction X1 and the second direction X2, respectively. The outer cylinder 13 is provided with a plurality of one-end side flanges 14, on the outer peripheral surface of the end in the first direction X1. The outer cylinder 13 is also provided with a plurality of other-end side flanges 15, on the outer peripheral surface of the end in the second direction X2. The other-end side flanges 15 are sometimes referred to as first flanges.

The motor peripheral part 12 includes a cover member 16 and a control unit (not illustrated) that is housed inside the cover member 16. The cover member 16 is disposed in the second direction X2 with respect to the outer cylinder 13. The cover member 16 is provided with a plurality of cover flanges 17 protruding outwards in radial directions. The cover flanges 17 are sometimes referred to as second flanges. The cover flanges 17 are disposed in the second direction X2 with respect to the other-end side flanges 15.

The first fasteners 100 are parts for connecting the motor 11 and the motor peripheral part 12. The first fasteners 100 according to the present embodiment each fasten the cover flange 17 against the other-end side flange 15, thereby connecting the motor 11 to the motor peripheral part 12. The first fasteners 100 according to the first embodiment each have a first bolt 101. In other words, the first fastener 100 consists only of the first bolt 101. The fastening structure of the first fastener 100 (first bolt 101) will be explained later.

The control unit (not illustrated) is a control unit that receives a detection signal from a torque sensor for detecting a torque applied to the steering pinion 2, and controls so that a desired assist torque is output from the output shaft 11a of the motor 11. The control unit includes a rotation angle sensor (not illustrated) for detecting a rotation angle of the output shaft 11a. This rotation angle sensor detects the rotation angle of the output shaft 11a by sensing a change in the magnetic field of the magnets fixed to the rotor. The rotation angle sensor may be, for example, a spin valve sensor, an anisotropic magnetoresistance (AMR) sensor, or a Hall sensor.

The reduction gear 20 includes a worm 21 provided integrally to the output shaft 11a, a worm wheel 22 meshing with the worm 21, and an assist pinion 23 integrally rotating with the worm wheel 22. The assist pinion 23 meshes with a second rack (not illustrated) provided to the rack bar 3. Based on the above, by driving the motor 11, an assisting force is exerted on the rack bar 3.

The housing 30 includes a cylindrical rack housing 31 for housing the rack bar 3, a pinion housing 32 for housing the steering pinion 2, and a reduction gear housing 33 for housing the reduction gear 20.

The rack housing 31 extends along the rack bar 3 in the axial direction. The rack housing 31 has four mounting portions 34 to be fixed to the body of the vehicle. The pinion housing 32 is located near an end of the rack housing 31 in the second direction X2. The reduction gear housing 33 is located near an end of the rack housing 31 in the first direction X1. The stay 40 is provided to the center of the rack housing 31 in the axial direction. The number of mounting portions 34 may be determined in any way.

The reduction gear housing 33 includes a motor mounting portion 33a on an end of the part where the worm 21 is housed in the second direction X2. The motor 11 is disposed in the second direction X2 with respect to the motor mounting portion 33a. A bolt 105 passing through the one-end side flange 14 of the motor 11 is screwed into the motor mounting portion 33a. With this, the power generator unit 10 has the end in the first direction X1 connected to the reduction gear housing 33. The motor mounting portion 33a also closes the opening of the outer cylinder 13 in the first direction X1. In the manner described above, the rack housing 31 supports the end of the power generator unit 10 in the first direction X1 via the reduction gear housing 33. Therefore, the reduction gear housing 33 is sometimes referred to as a first support in the explanation below.

As illustrated in FIG. 3, ribs 35 are provided to an outer peripheral surface 31a of the rack housing 31 to increase the rigidity of the rack housing 31. The ribs 35 extend in the axial direction and the circumferential direction. The outer peripheral surface 31a of the rack housing 31 is provided with a boss 36. The boss 36 is located at the center of the rack housing 31 in the axial direction. The boss 36 protrudes from the outer peripheral surface 31a, and has a cylindrical shape. An end face of the boss 36 serves as a seat 36a that abuts against a base portion 42 of the stay 40. A female threaded hole 37 is provided at the center of the seat 36a. A second bolt 102 is screwed into the female threaded hole 37, as illustrated in FIG. 4.

As illustrated in FIG. 4, the stay 40 is a part that connects the power generator unit 10 at a part near an end thereof in the second direction X2 to the rack housing 31. A centerline O2 of the first bolt 101 extends in the axial direction. By contrast, a centerline O3 of the second bolt 102 to be screwed extends radially with respect to the axial direction. Therefore, the centerline O2 of the first bolt 101 and the centerline O3 of the second bolt 102 do not extend in parallel with each other.

As illustrated in FIG. 5, the stay 40 is formed by changing the shape of a long plate-like metal piece. The stay 40 has a tip portion 41 connected to the power generator unit 10, a base portion 42 connected to the rack housing 31, and a middle part 43 extending between the tip portion 41 and the base portion 42.

The tip portion 41 has a circular first hole 41a formed through the metal piece in the thickness direction. The base portion 42 has a circular second hole 42a formed through the metal piece in the thickness direction. The middle part 43 is twisted in a direction from one end 43a that is continuous to the tip portion 41, toward the other end 43b that is continuous to the base portion 42, changing the orientation of the thickness direction of the metal piece.

With the stay 40, among the first hole 41a and the second hole 42a, which are holes formed through the metal piece in the thickness direction, one of such holes (first hole 41a) has an opening along the center line O2 of the first bolt 101, and the other (second hole 42a) has an opening along the center line O3 of the second bolt 102, due to the presence of the middle part 43. With such a configuration, the tip portion 41 of the stay 40 is fastened and fixed to the power generator unit 10 by the first bolt 101. The base portion 42 of the stay 40 is fastened and fixed to the rack housing 31 by the second bolt 102.

In the manner described above, the rack housing 31 supports the part near the end of the power generator unit 10 in the second direction X2 via the stay 40. Therefore, the stay 40 is sometimes referred to as a second support in the explanation below. A fastening structure using the first bolt 101 and the second bolt 102 will now be explained in detail using FIGS. 6 and 7.

As illustrated in FIG. 6, the tip portion 41 of the stay 40 is disposed in the second direction X2 with respect to the cover flange 17. In other words, the other-end side flange 15, the cover flange 17, and the tip portion 41 are arranged in the order listed herein toward the second direction X2. The other-end side flange 15 has a hole 15a formed therethrough in the axial direction. The inner peripheral surface of the hole 15a in the other-end side flange 15 has a threaded groove. In other words, the hole 15a is a female threaded hole. The cover flange 17 has a hole 17a formed therethrough in the axial direction. The hole 17a has a larger diameter than the hole 15a, and is a through hole through which a shaft 101a of the first bolt 101 passes. The first hole 41a provided to the tip portion 41 is disposed in a manner overlapping with the hole 15a and the hole 17a in the axial direction.

The shaft 101a of the first bolt 101 passes through the first hole 41a and the hole 17a, and is screwed into the hole 15a. A head 101b of the first bolt 101 fastens the tip portion 41 and the cover flange 17 against the other-end side flange 15. In this manner, the first bolt 101 connects the power generator unit 10 (the motor 11 and the motor peripheral part 12) and the tip portion 41 of the stay 40.

The end of the power generator unit 10 in the first direction X1 is supported by the reduction gear housing 33 (see FIG. 2). Therefore, the first bolt 101 screwed into the other-end side flange 15 of the power generator unit 10 may become displaced with respect to a predetermined position because of an assembly tolerance between the power generator unit 10 and the reduction gear housing 33. Meanwhile, the first hole 41a provided to the tip portion 41 is larger than the hole 17a provided to the cover flange 17, as illustrated in FIG. 6. In other words, the first hole 41a is larger than the shaft 101a of the first bolt 101. Therefore, some radial displacement of the shaft 101a of the first bolt 101 with respect to the centerline O2 is tolerated. With this, the ease of installation of the stay 40 is improved.

In addition, the shaft 101a of the first bolt 101 protrudes in the first direction X1 from a first surface 15b of the other-end side flange 15. A second surface 15c of the other-end side flange 15 is in abutment against a first surface 17b of the cover flange 17. A second surface 17c of the cover flange 17 is in abutment against a first surface 41b of the tip portion 41. In addition, a washer 110 is provided between a second surface 41c of the tip portion 41 and the head 101b, in order to prevent loosening of the first bolt 101.

As illustrated in FIG. 7, the base portion 42 of the stay 40 is in abutment against the seat 36a of the boss 36. The second hole 42a provided to the base portion 42 is disposed in a manner overlapping with the female threaded hole 37. A shaft 102a of the second bolt 102 passes through the second hole 42a, and is screwed into the female threaded hole 37. A head 102b of the second bolt 102 fastens the base portion 42 against the boss 36. In this manner, the second bolt 102 connects the rack housing 31 and the base portion 42 of the stay 40.

The second hole 42a has a larger diameter than that of the shaft 102a of the second bolt 102. With this, the position where the stay 40 is to be mounted can be moved in the radial directions with respect to the centerline O3 of the shaft 102a of the second bolt 102 (see FIG. 4). In other words, the position at which the stay 40 is mounted on the rack housing 31 can be adjusted. If the cover flange 17 and the tip portion 41 of the stay 40 become separated and a gap is formed in the axial direction because of the assembly tolerance, the stay 40 can be moved in the first direction X1 to bring the tip portion 41 of the stay 40 into abutment against the cover flange 17. In other words, a displacement caused by the assembly tolerance can be tolerated, so that ease of mounting the stay 40 is improved.

The first hole 41a can tolerate a displacement of the first bolt 101 within a range in the radial direction with respect to the centerline O2 of the first bolt 101. By contrast, the direction in which the second hole 42a enables the adjustment of the position is in the radial direction with respect to the centerline O3 of the second bolt 102, which is different from the direction in which the first hole 41a enables. Therefore, the first hole 41a and the second hole 42a make the stay 40 much easier to install.

The amount by which the boss 36 protrudes is less than that by which the rib 35 protrudes. Generally, the rack housing 31 is formed by casting, but it becomes difficult to form when a protrusion protruding by a large amount is to be manufactured on the outer peripheral surface. Therefore, even if the rack housing 31 is provided with the boss 36 protruding less than the rib 35, which is an existing configuration, the design of the mold (so-called casting plan) for the rack housing 31 is not affected very much. Therefore, the rack housing 31 can be manufactured as conventionally done. The amount by which the boss 36 according to the present disclosure protrudes may be the same as that by which the rib 35 protrudes. This is because, even with such a configuration, the design of the mold (so-called casting plan) for the rack housing 31 is not affected very much and such a configuration is preferable.

The motor supporting structure in the electric power steering device 1 according to the first embodiment described above includes the rack bar 3, the rack housing 31 in which the rack bar 3 is housed, and the power generator unit 10 for generating the power to move the rack bar 3. The power generator unit 10 includes the motor 11 one end of which has the output shaft 11a extending along the axial direction of the rack bar 3, the motor peripheral part 12 disposed on the other end of the motor 11, and the first fastener 100 including the first bolt 101 and fastening the motor 11 and the motor peripheral part 12 in the axial direction. The rack housing 31 includes the first support (reduction gear housing 33) that supports one end of the power generator unit 10 and the second support (stay 40) that supports the other end of the power generator unit 10. The second support (stay 40) has the tip portion 41 connected to the other end of the motor 11. The tip portion 41 of the second support (stay 40) has the first hole 41a through which the shaft 101a of the first bolt 101 passes. The tip portion 41 is fastened by the first fastener 100, together with the motor 11 and the motor peripheral part 12.

The tip portion 41 of the second support (stay 40) is fastened by the first fastener 100 (first bolt 101), to be connected to the other end (near the end in the second direction X2) of the power generator unit 10. In other words, the fastener for connecting the motor 11 to the motor peripheral part 12 is also used as the fastener for connecting the second support (stay 40) to the power generator unit 10. With the structure described above, because the need for one of the fasteners is eliminated, the number of parts is reduced. In addition, because the need for one fastener is eliminated, the work for forming a female threaded hole in the motor 11 or the motor peripheral part 12 is reduced, so that the number of man-hours required to manufacture the electric power steering device 1 is also reduced.

The motor 11 according to the first embodiment includes the first flange (other-end side flange 15) protruding from the outer peripheral surface of the other end of the motor 11 and fastened by the first fastener 100. The motor peripheral part 12 includes the cover member 16 that closes the opening on the other end of the motor 11. The cover member 16 has the second flange (cover flange 17) that is fastened by the first fastener 100 and that abuts against the first flange (other-end side flange 15).

The second support (stay 40) is not interposed between the first flange (other-end side flange 15) and the second flange (cover flange 17). This configuration suppresses formation of a gap between the motor 11 and the cover member 16, so that sealing of the cover member 16 is ensured. As a result, it is less likely for a foreign substance or liquid to enter the motor 11 through the opening on the other end of the motor 11.

The rotor of the motor 11 according to the first embodiment is provided with magnets. The motor peripheral part 12 includes a rotation angle sensor that detects a change in the magnetic field of the magnets.

As mentioned earlier, the distance between the rotation angle sensor and the magnets is short because the second support (stay 40) is not interposed between the first flange (other-end side flange 15) and the second flange (cover flange 17). Therefore, the rotation angle sensor can detect a change in the magnetic field of the magnets accurately.

In the first embodiment, the motor 11 or the motor peripheral part 12 is provided with the female threaded hole into which the first bolt 101 is screwed. More specifically, the hole 15a of the other-end side flange 15 of the motor 11 provides the female threaded hole.

Because the need for a nut into which the first bolt 101 is screwed is thus eliminated, the number of parts is reduced.

Furthermore, the first hole 41a according to the first embodiment is larger than the diameter of the shaft 101a of the first bolt 101.

With the first hole 41a, displacement of the first bolt 101 in the radial directions (radial directions with respect to the center line O2 in FIG. 4) is tolerated. Therefore, the ease of installation of the second support (stay 40) is improved.

The second support (stay 40) according to the first embodiment has the base portion 42 that is an end on the opposite side of the tip portion 41, and is provided with the second hole 42a. The base portion 42 is fastened to the rack housing 31 by the second bolt 102.

Because the second support (stay 40) is a body separate from the rack housing 31, it is possible to replace only the second support (stay 40). Therefore, it is highly convenient because only the second support (stay 40) can be replaced when the second support (stay 40) is damaged or the like.

The rack housing 31 according to the first embodiment also includes the ribs 35 that protrude from the outer peripheral surface 31a of the rack housing 31 to increase the strength of the rack housing 31, and the boss 36 that protrudes from the outer peripheral surface 31a of the rack housing 31 and into which the second bolt 102 is screwed. The amount by which the boss 36 protrudes is equal to or less than that by which the rib 35 protrudes.

Although the boss 36 is provided to the rack housing 31, the boss 36 has little impact on the design of the mold (so-called casting plan) for the rack housing. Therefore, the rack housing 31 can be manufactured as conventionally done.

Furthermore, the second hole 42a is larger than the diameter of the shaft 102a of the second bolt 102.

The second support (stay 40) can be radially moved about the shaft 102a of the second bolt 102, and be fixed to the rack housing 31. Therefore, displacement due to the assembly tolerance can be tolerated, and the ease of installation of the second support (stay 40) is improved.

The second support (stay 40) according to the first embodiment is formed by changing the shape of a long plate-like metal piece. The first hole 41a and the second hole 42a are provided as holes formed through the metal piece in the thickness direction. The second support (stay 40) has the middle part 43 extending between the tip portion 41 and the base portion 42. The middle part 43 is twisted, and the first hole 41a and the second hole 42a face different directions.

With this, because the second support (stay 40) is plate-shaped, it is possible to reduce the weight. Furthermore, the second support (stay 40) has the twisted middle part 43 that allows the first hole 41a and the second hole 42a to face different directions. Therefore, it is possible to accommodate not only the direction in which the shaft 101a of the first bolt 101 passes therethrough, but also the direction in which the shaft 102a of the second bolt 102 passes therethrough.

Other embodiments of the motor supporting structure of the electric power steering device according to the present disclosure will now be explained. In the explanation below, elements that are the same as those described in the first embodiment are given the same reference signs, and redundant explanations thereof will be omitted.

### Second Embodiment

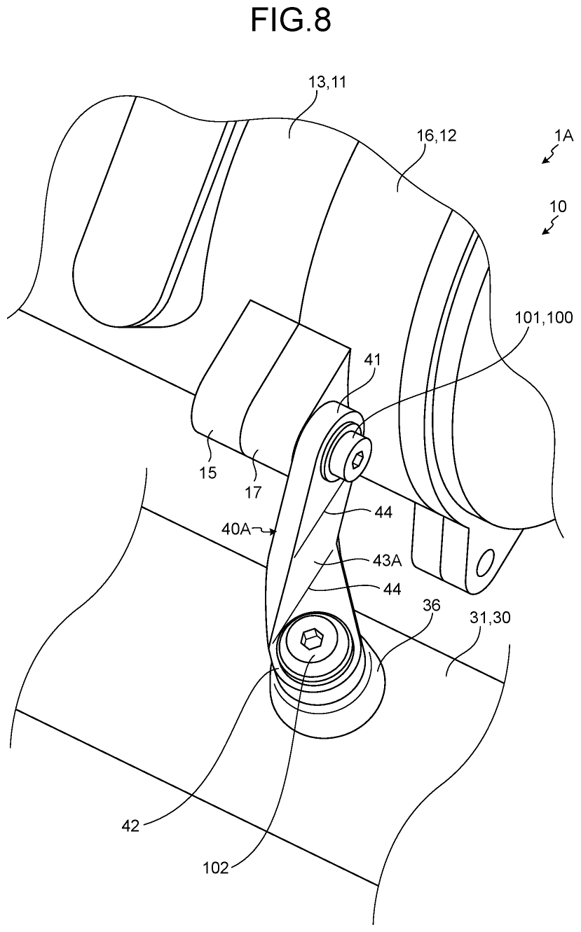

FIG. 8 is an enlarged view of the elements near a stay in an electric power steering device according to a second embodiment. An electric power steering device 1A according to the second embodiment is different from the electric power steering device 1 according to the first embodiment in having a stay 40A instead of the stay 40. The difference will be focused on in the explanation below.

The stay 40A that is the second support has a middle part 43A extending between the tip portion 41 and the base portion 42. The middle part 43A is bent at a connection portion with the tip portion 41 and at a connection portion 44 with the base portion 42. Each connection portion 44 is a diagonal line in which the metal piece making up the stay 40A is folded. With this connection portions 44 each provided as a diagonal folded line, the first hole (not illustrated in FIG. 8) and the second hole (not illustrated in FIG. 8) provided as holes formed through the metal piece in the thickness direction face different directions.

According to this second embodiment, with the middle part 43A, it is possible to accommodate not only the direction in which the shaft 101a of the first bolt 101 passes therethrough, but also the direction in which the shaft 102a of the second bolt 102 passes therethrough.

### Third Embodiment

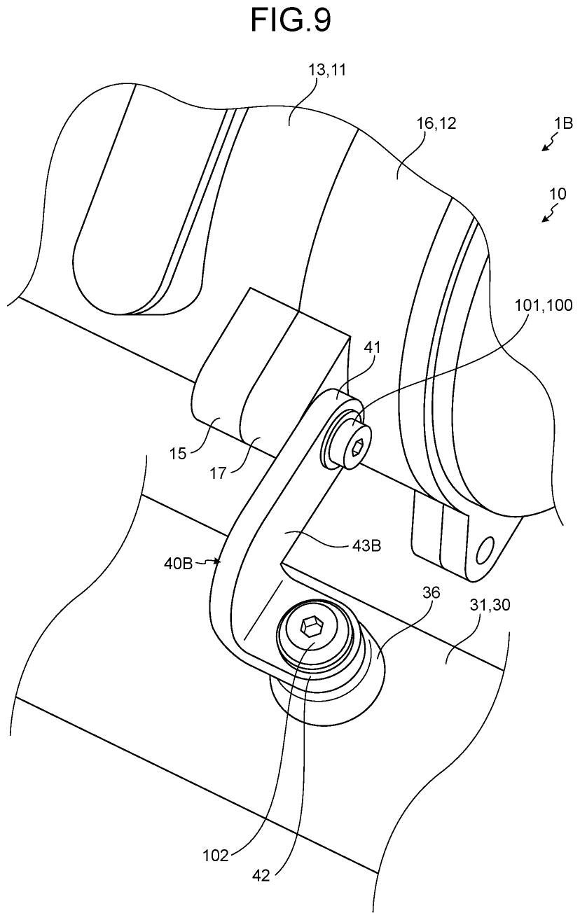

FIG. 9 is an enlarged view of the elements near a stay in an electric power steering device according to a third embodiment. An electric power steering device 1B according to the third embodiment is different from the electric power steering device 1 according to the first embodiment in having a stay 40B instead of the stay 40. A middle part 43B of the stay 40B according to the second embodiment is on the same plane as the tip portion 41. In other words, the middle part 43B is on a plane having the center line O3 of the shaft 101a of the first bolt 101 as a perpendicular. In the middle part 43B, a connection portion 45 with the base portion 42 is bent at a right angle. Even with such a stay 40B, it is possible to configure the first hole (not illustrated in FIG. 9) and the second hole (not illustrated in FIG. 9) provided as holes formed through the metal piece in the thickness direction to face different directions.

### Fourth Embodiment

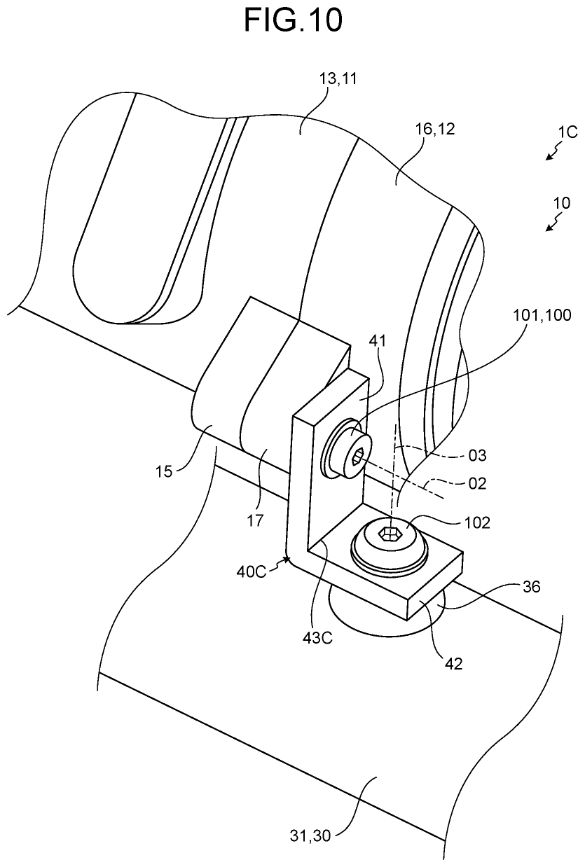

FIG. 10 is an enlarged view of the elements near a stay in an electric power steering device according to a fourth embodiment. An electric power steering device 1C according to the fourth embodiment is different from the electric power steering device 1 according to the first embodiment in having a stay 40C instead of the stay 40.

A middle part 43C of the stay (second support) 40C is a connection portion that connects the tip portion 41 and the base portion 42 in a bent state at 90°. With this, the length of the stay 40C is shorter than those of the stays 40, 40A, and 40B according to the first to the third embodiments, and better support rigidity for supporting the other end of the power generator unit 10 is achieved. When such a stay 40C is used, it is necessary to position the boss 36 in such a manner that the centerline O2 of the first bolt 101 and the centerline O3 of the second bolt 102 are on the same plane and also orthogonal to each other.

### Fifth Embodiment

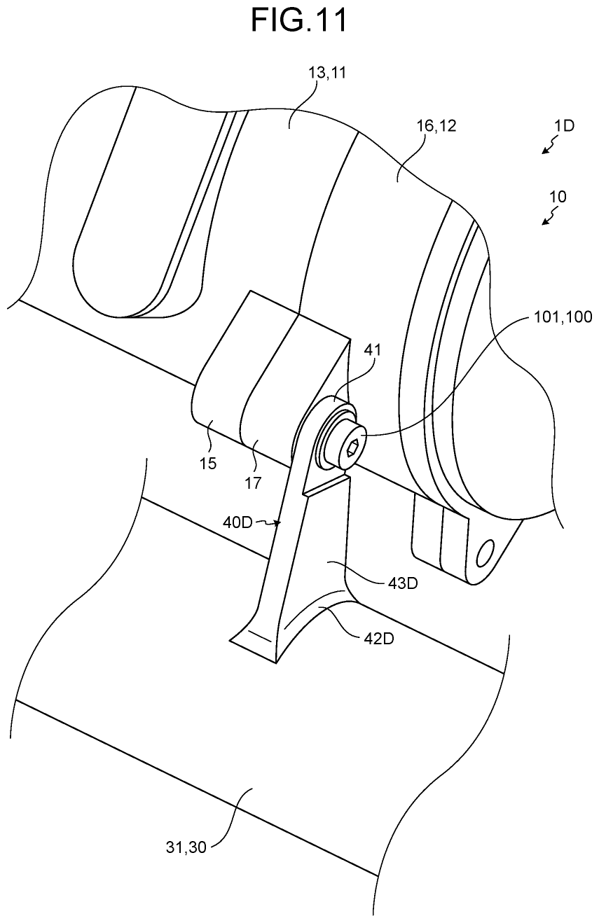

FIG. 11 is an enlarged view of the elements near a stay in an electric power steering device according to a fifth embodiment. An electric power steering device 1D according to the fifth embodiment is different from the electric power steering device 1 according to the first embodiment in having a stay 40D instead of the stay 40.

The stay 40D that is the second support is manufactured integrally with the rack housing 31. In other words, a base portion 42D of the stay 40D is continuous to the outer peripheral surface 31a of the rack housing 31. The stay 40D is configured so that a middle part 43D of the stay 40D is on a plane having the center line O2 of the first bolt 101 as a perpendicular. Therefore, the stay 40D itself is flat. This eliminates the need for the second bolt connecting the stay 40D that is the second support to the rack housing 31, so that the number of parts is reduced.

### Sixth Embodiment

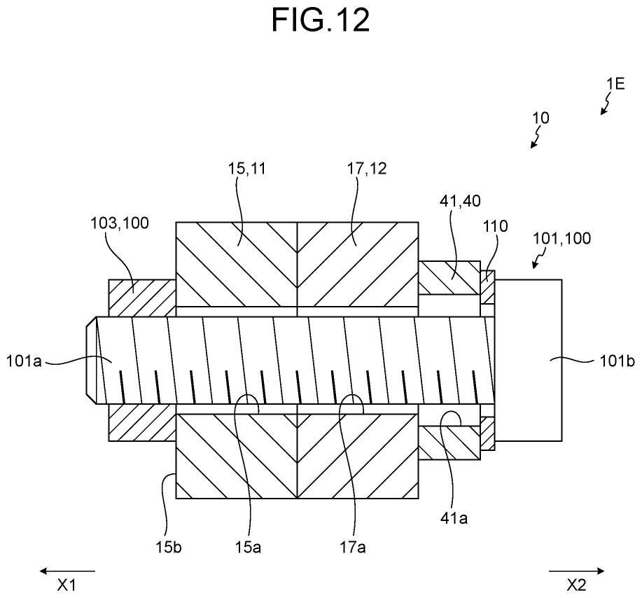

FIG. 12 is a cross-sectional view cut along the shaft of a first bolt of an electric power steering device according to a sixth embodiment. An electric power steering device 1E according to the sixth embodiment is different from the electric power steering device 1 according to the first embodiment in that the first fastener 100 includes a nut 103.

The first fastener 100 has the first bolt 101 and the nut 103. The nut 103 is disposed on the first surface 15b of the other-end side flange 15 in the first direction X1. The shaft 101a of the first bolt 101 passes through the tip portion 41 of the stay 40, the cover flange 17, and the other-end side flange 15, and the nut 103 is screwed thereon. The head 101b of the first bolt 101 and the nut 103 fasten the tip portion 41, the cover flange 17, and the other-end side flange 15. The hole 15a provided to the other-end side flange 15 has a larger diameter than the shaft 101a because the shaft 101a is not screwed thereon. Based on the above, the first fastener 100 may have the first bolt 101 and the nut 103.

### Seventh Embodiment

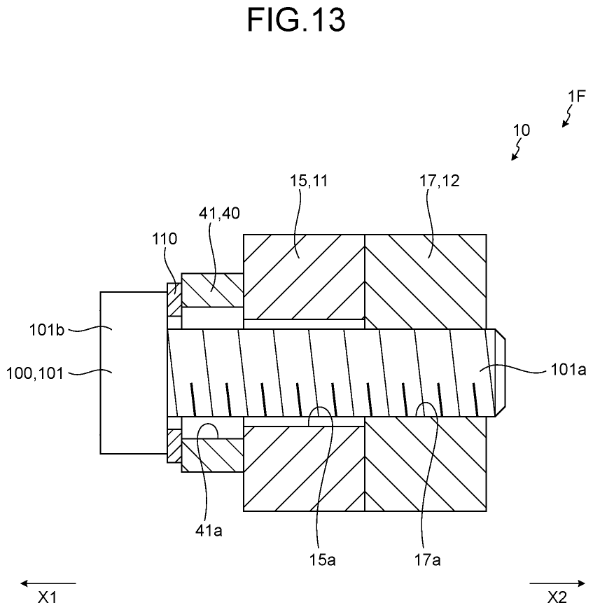

FIG. 13 is a cross-sectional view cut along the shaft of a first bolt of an electric power steering device according to a seventh embodiment. An electric power steering device 1F according to the seventh embodiment is different from the electric power steering device 1 according to the first embodiment in that the first bolt 101 extends in a different direction. The tip portion 41 of the stay 40 is disposed in the first direction X1 of the other-end side flange 15. The hole 15a provided to the other-end side flange 15 is a through hole, and the hole 17a in the cover flange 17 is a female threaded hole. The first bolt 101 is inserted into the first hole 41a of the tip portion 41 from the first direction X1 of the other-end side flange 15, passes through the hole 15a of the other-end side flange 15, and is screwed into the hole 17a of the cover flange 17. The head 101b of the first bolt 101 fastens the tip portion 41 and the other-end side flange 15 in the second direction X2. Based on the above, according to the present disclosure, the direction in which the first bolt 101 is inserted is not limited to a particular example.

### Eighth Embodiment

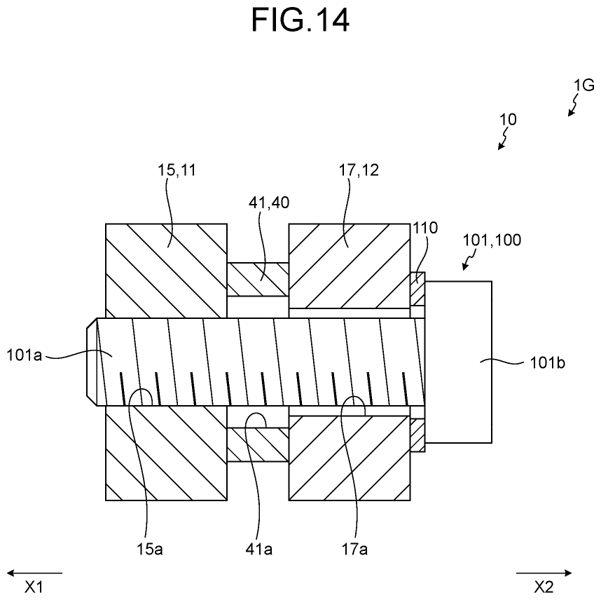

FIG. 14 is a cross-sectional view cut along the shaft of a first bolt of an electric power steering device according to an eighth embodiment. An electric power steering device 1G according to the eighth embodiment is different from the electric power steering device 1 according to the first embodiment in that the tip portion 41 of the stay 40 is interposed between the other-end side flange 15 and the cover flange 17. With such an electric power steering device 1G according to the eighth embodiment, it is possible to fix the tip portion 41 of the stay 40 to the other end of the power generator unit 10. When the tip portion 41 of the stay 40 is interposed between the other-end side flange 15 and the cover flange 17, the outer cylinder 13 of the motor 11 and the cover member 16 are axially separated from each other. Therefore, it is necessary to change the design so that the cover member 16 is capable of sealing the opening of the outer cylinder 13 in the second direction X2.

### Ninth Embodiment

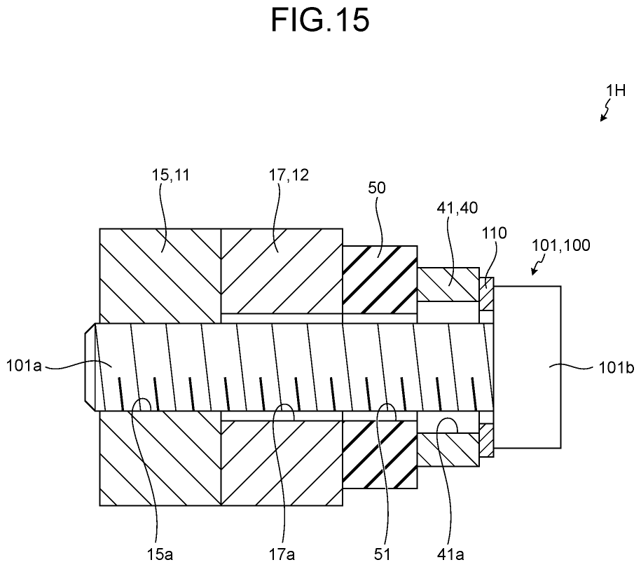

FIG. 15 is a cross-sectional view cut along the shaft of a first bolt of an electric power steering device according to a ninth embodiment. An electric power steering device 1H according to the ninth embodiment is different from the electric power steering device 1 according to the first embodiment in that an elastic material 50 is interposed between the tip portion 41 of the stay 40 and the cover flange 17 that is adjacent thereto in the axial direction. The elastic material 50 has a hole 51 through which the shaft 101a passes, and is annular.

As described above, in the eighth embodiment, the elastic material 50 is interposed between the tip portion 41 of the stay 40 that is the second support and the other-end side flange (first flange) 15 or the second flange (cover flange) 17 that is adjacent thereto in the axial direction. With this configuration, vibrations transmitted from the other-end side flange 15 or the cover flange 17 to the stay 40 are absorbed by the elastic material 50. Therefore, the stay 40 vibrates less, and the stay 40 generates less vibrational noise.

The electric power steering devices 1, 1A, 1B, 1C, 1D, 1E, 1F, 1G, and 1H according to the first to the ninth embodiments have been explained above, but the present disclosure is not limited to the examples described in the embodiments. For example, the motor 11 and the motor peripheral part 12 have flanges (the other-end side flanges 15 and the cover flanges 17) that are fastened by the first fasteners 100, but it is possible for such flanges not to be provided in the present disclosure. In other words, the shaft 101a of the first bolt 101 may pass through the end face of the cover member 16 in the second direction X2 and be screwed into a female thread provided inside the outer cylinder 13 of the motor 11. Even in such an example, it is possible to reduce the number of parts, and to reduce the number of man-hours required to manufacture the electric power steering device. The reduction gear 20 in the electric power steering device may be a combination of a pulley device (including a drive pulley, a driven pulley, and a belt) and a ball screw device. The cross-sectional shape of the first hole 41a and the second hole 42a may be elongated holes, instead of circular holes. In other words, even if the first hole 41a and the second hole 42a are elongated holes, displacement due to the assembly tolerance can be tolerated. The motor supporting structure explained in the present disclosure may also be applied to what is called a single-pinion electric power steering device in which the torque generated by the motor 11 is applied to the steering pinion 2.

Furthermore, the elastic material 50 may be interposed between the base portion 42 of the stay 40 and the boss 36 of the rack housing 31. With such a configuration, the elastic material 50 absorbs the vibrations transmitted from the rack housing 31 to the stay 40. The stay 40 thus vibrates less, and the stay 40 generates less vibrational noise. Explained in the embodiments are examples in which the present disclosure is applied to an electric power steering device, but the steering device according to the present disclosure may also be applied to a steer-by-wire device. In other words, the present disclosure may be applied to a supporting structure that supports a steering actuator (motor) for driving a rack bar in response to a steering operation, in a steer-by-wire device.

### REFERENCE SIGNS LIST

1, 1A, 1B, 1C, 1D, 1E, 1F, 1G, 1H electric power steering device (steering device)
2 steering pinion
3 rack bar
10 power generator unit
20 reduction gear
30 housing
11 motor
11a output shaft
12 motor peripheral part
13 outer cylinder
15 other-end side flange (first flange)
16 cover member
17 cover flange (second flange)
23 assist pinion
31 rack housing
33 reduction gear housing (first support)
35 rib
36 boss
40, 40A, 40B, 40C, 40D stay (second support)
41 tip portion
41a first hole
42, 42D base portion
42a second hole
43, 43A, 43B, 43C, 43D middle part
50 elastic material
100 first fastener
101 first bolt
101a shaft
101b head
102 second bolt
102a shaft
103 nut

1. A motor supporting structure for a steering device, the motor supporting structure comprising:
a rack bar;
a rack housing in which the rack bar is housed; and
a power generator unit that generates power for moving the rack bar, wherein
the power generator unit includes:
a motor one end of which has an output shaft extending along an axial direction of the rack bar;
a motor peripheral part that is disposed on another end of the motor; and
a first fastener that includes a first bolt, and that fastens the motor and the motor peripheral part in an axial direction,
the rack housing includes:
a first support that supports one end of the power generator unit; and
a second support that supports another end of the power generator unit,
the second support has a tip portion that is connected to the other end of the power generator unit, and
the tip portion of the second support has a first hole through which a shaft of the first bolt passes, and is fastened by the first fastener, together with the motor and the motor peripheral part.

2. The motor supporting structure for a steering device according to claim 1, wherein
the motor has a first flange that protrudes from an outer peripheral surface of the other end of the motor and that is fastened by the first fastener,
the motor peripheral part has a cover member that closes an opening on the other end of the motor, and
the cover member has a second flange that is fastened by the first fastener and that abuts against the first flange.

3. The motor supporting structure for a steering device according to claim 2, wherein
a rotor of the motor includes a magnet, and
the motor peripheral part has a rotation angle sensor that detects a change in a magnetic field of the magnet.

4. The motor supporting structure for a steering device according to claim 2, wherein an elastic material is interposed between the tip portion of the second support and the first flange or the second flange adjacent to the tip portion in the axial direction.

5. The motor supporting structure for a steering device according to claim 1, wherein the motor or the motor peripheral part is provided with a female threaded hole into which the first bolt is screwed.

6. The motor supporting structure for a steering device according to claim 1, wherein the first hole is larger than a diameter of a shaft of the first bolt.

7. The motor supporting structure for a steering device according to claim 1, wherein the second support is manufactured integrally with the rack housing.

8. The motor supporting structure for a steering device according to claim 1, wherein
the second support has a base portion that is an end on an opposite side of the tip portion and provided with a second hole, and
the base portion is fastened to the rack housing by a second bolt.

9. The motor supporting structure for a steering device according to claim 8, wherein an elastic material is interposed between the base portion of the second support and the rack housing.

10. The motor supporting structure for a steering device according to claim 8, wherein the rack housing has:
a rib that protrudes from an outer peripheral surface of the rack housing to increase strength of the rack housing; and
a boss that protrudes from the outer peripheral surface of the rack housing, and into which the second bolt is screwed, and
an amount by which the boss protrudes is equal to or less than an amount by which the rib protrudes.

11. The motor supporting structure for a steering device according to claim 8, wherein the second hole is larger than a diameter of the shaft of the second bolt.

12. The motor supporting structure for a steering device according to claim 8, wherein
the second support is formed by changing shape of a long plate-like metal piece,
the first hole and the second hole are formed through the metal piece in a thickness direction,
the second support has a middle part extending between the tip portion and the base portion, and
the middle part is twisted, and the first hole and the second hole face different directions.

13. The motor supporting structure for a steering device according to claim 8, wherein
the second support is formed by changing shape of a long plate-like metal piece,
the first hole and the second hole are formed through the metal piece in a thickness direction,
the second support has a middle part extending between the tip portion and the base portion, and
the middle part is bent, and the first hole and the second hole face different directions.

14. The motor supporting structure for a steering device according to claim 13, wherein the second support has an L shape.
